(19) United States
(12) Patent Application Publication
(10) Pub. No.: US 2011/0265072 A1
(43) Pub. Date: Oct. 27, 2011

(54) Dynamic Installation of Files for Running Programs

(76) Inventor: Jack Matthew, San Francisco, CA (US)

(21) Appl. No.: 12/768,574

(22) Filed: Apr. 27, 2010

(51) Int. Cl. G06F 9/445; G06F 9/44

(52) U.S. Cl. 717/169

(57) ABSTRACT

A method and apparatus for dynamic installation of files for running programs is described herein. In one embodiment, a process can be provided to save an update to a software program in a temporary location in a file system. A determination can be made as to whether an active software program has a dependency on the update. If a determination is made that an active software program has a dependency on the update, the system can wait until the active software program is terminated. Once the software program has terminated, the update can be moved from the temporary location in the file system to a final location in the file system.

### FIELD OF THE INVENTION

The field of invention relates generally to computing systems, and, more specifically, to dynamic installation of files for running programs.

### BACKGROUND

The average computer generally has several programs or applications running on it. However, an upgrade or an update to a running program may be required. This upgrade or update may affect the manner in which the running program operates.

### SUMMARY OF THE DESCRIPTION

Mechanisms for dynamic installation of files for a running program are described herein. In one embodiment, a process can be provided to save an update to a software program in a temporary location in a file system. A determination can be made as to whether an active software program has a dependency on the update. If a determination is made that an active software program has a dependency on the update, the system can wait until the active software program is terminated. Once the software program has terminated, the update can be moved from the temporary location in the file system to a final location in the file system. Systems, methods, and machine readable storage media which perform or implement one or more embodiments are also described.

Other features of the present invention will be apparent from the accompanying drawings and from the detailed description which follows.

### BRIEF DESCRIPTION OF THE DRAWINGS

The present invention is illustrated by way of example and not limited in the figures of the accompanying drawings, in which like references indicate similar elements and in which:

FIG. 1 illustrates a block diagram of an exemplary computer system in which embodiments of the present invention may operate;

FIG. 2 illustrates an exemplary memory in accordance with one embodiment of the present invention;

FIG. 3 illustrates an exemplary memory prior to dynamic installation of files in accordance with embodiments of the present invention;

FIG. 4 illustrates an exemplary memory after dynamic installation of files in accordance with embodiments of the present invention;

FIG. 5 illustrates a flow diagram of a method of dynamic installation of files in accordance with embodiments of the present invention;

FIG. 6 illustrates a flow diagram of an alternate method of dynamic installation of files in accordance with embodiments of the present invention;

FIG. 7 illustrates a flow diagram of a method of determining whether an update is safe in accordance with embodiments of the present invention;

FIG. 8 illustrates a flow diagram of a method of updating a program in accordance with embodiments of the present invention; and

FIG. 9 illustrates a flow diagram of an alternate method of updating a program in accordance with embodiments of the present invention.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

Installation of updates to a software program or libraries on which the software program depends may affect the operability of the software program. Therefore, updating a software program while the software program is running or in use can be unsafe. If an update to a software program or a library is required, it can be possible to place the update in a temporary location in the file system prior to the installation of the update and determine if it is safe to install the update. In one embodiment, it can be safe to install the update when no running software programs depend on the update. Once it is safe to install the update (e.g., all running programs which depend on the update have been terminated), the update can be moved from the temporary location in the file system to its final location in the file system.

In one embodiment, a portion of the update on which the running software program does not depend can be installed prior to it being safe to install the portion of the update on which the running software program does depend. The portion on which the running software depends can then installed once it is safe to install the update.

In one embodiment, interaction of a user of the system is not required. The update can be installed once the user has terminated a software program which depends on the update without requiring the user to be notified of the dependency. In one embodiment, the user is not be notified that the update has been made.

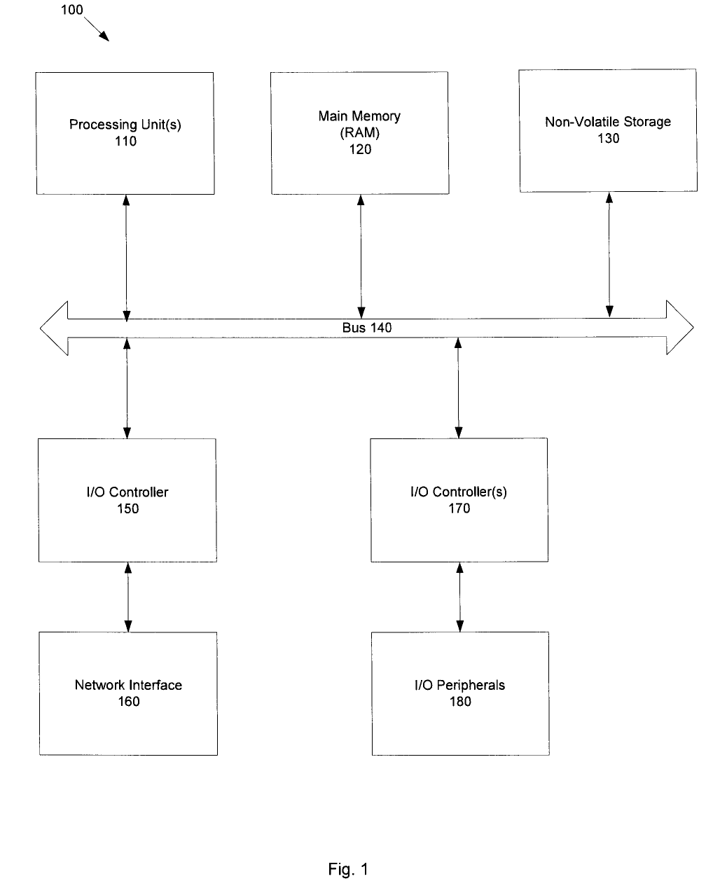

FIG. 1 is a block diagram of an exemplary computer system in which embodiments of the present invention may operate. Computer system 100 includes processing unit(s) 110, main memory (RAM) 120, non-volatile storage 130, bus 140, I/O controller 150, network interface 160, I/O controller 170, and I/O peripherals 180.

Main memory 120 encompasses all volatile or non-volatile storage media, such as dynamic random access memory (DRAM), static RAM (SRAM), or flash memory. Main memory 120 includes storage locations that are addressable by the processing unit(s) 110 for storing computer program code and data structures for determining and quarantining incompatible applications. Such computer program code and data structures also may be stored in non-volatile storage 130. Non-volatile storage 130 includes all non-volatile storage media, such as any type of disk including floppy disks, optical disks such as CDs, DVDs and BDs (Blu-ray Disks), and magnetic-optical disks, magnetic or optical cards, or any type of media, and may be loaded onto the main memory 120. Those skilled in the art will immediately recognize that the term “computer-readable storage medium” or “machine readable storage medium” includes any type of volatile or non-volatile storage device that is accessible by a processor (including main memory 120 and non-volatile storage 130).

Processing unit(s) 110 is coupled to main memory 120 and non-volatile storage 130 through bus 140. Processing unit(s) 110 includes processing elements and/or logic circuitry configured to execute the computer program code and manipulate the data structures. It will be apparent to those skilled in the art that other processing and memory means, including various computer readable storage media, may be used for storing and executing computer program code pertaining to dynamic installation of files for running programs.

Processing unit(s) 110 can retrieve instructions from main memory 120 and non-volatile storage 130 via bus 140 and execute the instructions to perform operations described below. Bus 140 is coupled to I/O controller 150. I/O controller 150 is also coupled to network interface 160. Network interface 160 can connect to a network to download an incompatibility list that identifies non-priority software incompatible with priority software to be installed or already installed on computer system 100.

Bus 140 is further coupled to I/O controller(s) 170. I/O controller(s) 170 are coupled to I/O peripherals 180, which may be mice, keyboards, modems, disk drives, optical drives, printers and other devices which are well known in the art.

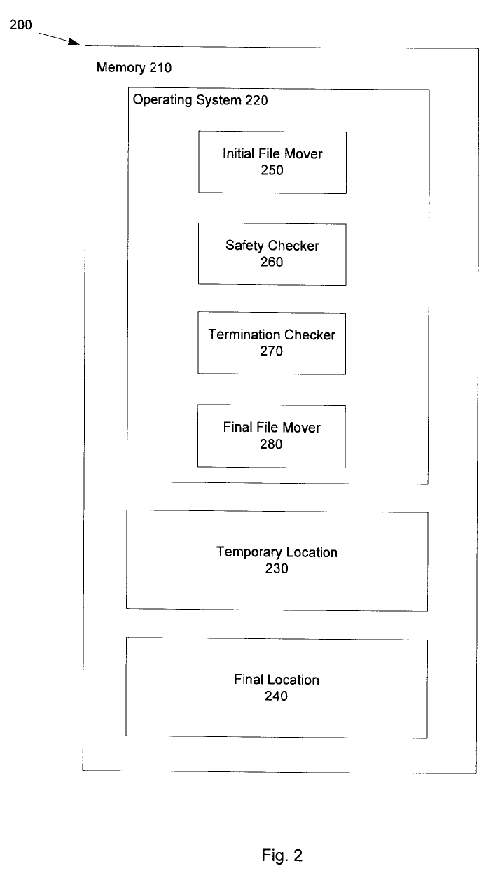

FIG. 2 illustrates an exemplary main memory 120 of FIG. 1 in accordance with one embodiment. Referring to FIG. 2, memory 210 contains operating system 220, temporary location 230, and final location 240. Within operating system 220, there is initial file mover 250, safety checker 260, termination checker 270, and final file mover 280. In other embodiments, the software components 250, 260, 270, and 280 can be separate from and not part of an operating system. Although memory 210 has been shown as a single memory, this is just one illustrative embodiment. In alternate embodiments, memory 210 can be split into more than one memory.

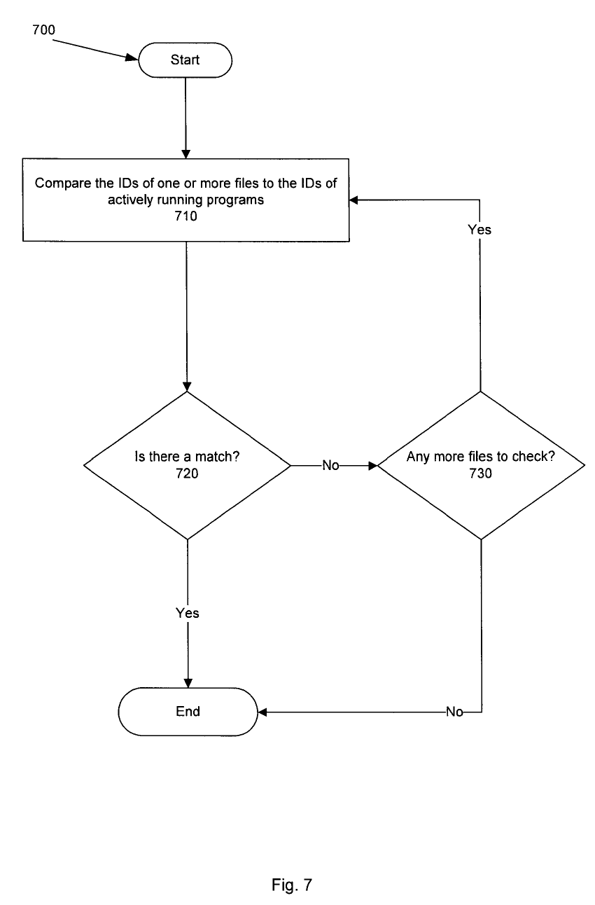

Safety checker 260 determines whether it is safe to install an update. In one embodiment, safety checker 260 can compare the identification information of the update stored in temporary location 230 with the identification information of the actively running programs on the system. In one embodiment, an actively running program can be a software program currently executing on the system. In one embodiment, if the identification information of the update compares in a predetermined manner (e.g., matches or is equivalent to) the identification information of one or more of the actively running programs, safety checker 260 determines that it is not safe to install the update. In one embodiment, if the update contains more than one file to be updated, safety checker 260 can compare the identification information of each file in the update to the identification information of each actively running program. In one embodiment, if the identification information of any file in the update compares in a predetermined manner (e.g., matches or is equivalent to) the identification information of any of the actively running program, safety checker 260 can determine that all of the files in the update are not safe to install. In an alternate embodiment, if the identification information of any file in the update compares in a predetermined manner (e.g., matches or is equivalent to) the identification information of any of the actively running program, safety checker 260 can determine that only the files on which the actively running program depend are not safe to install. The determining of whether an update is safe is described below in conjunction with FIG. 7. In one embodiment, once the determination has been made of whether an update is safe, safety checker 260 can send the outcome of the determination to termination checker 240.

Initial file mover 250 moves one or more files associated with an update to a software program or a library to temporary location 230. In one embodiment, initial file mover 250 can move the update to temporary location 230 prior to safety checker 260 performing a safety check as described above. In an alternate embodiment, initial file mover 250 can move the update to temporary location 230 only in response to safety checker 260 determining that the update is not safe to install. In yet another alternate embodiment, initial file mover 250 can move the files associated with the update on which the actively running program depends on to temporary location 230 without moving the files associated with the update on which the actively running program does not depend.

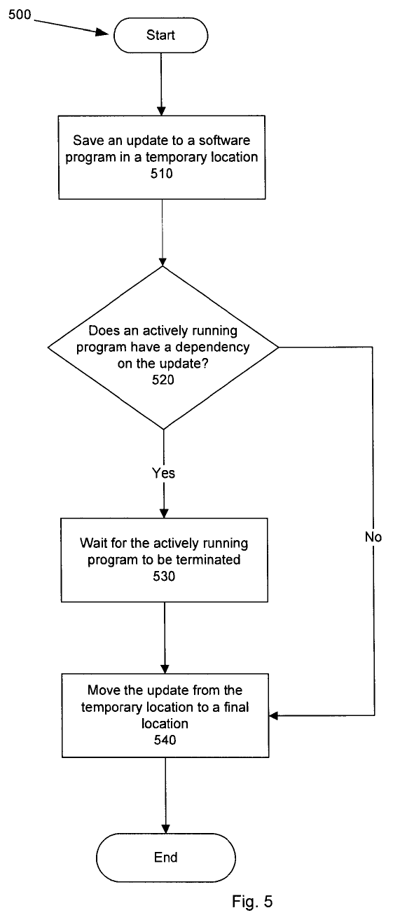

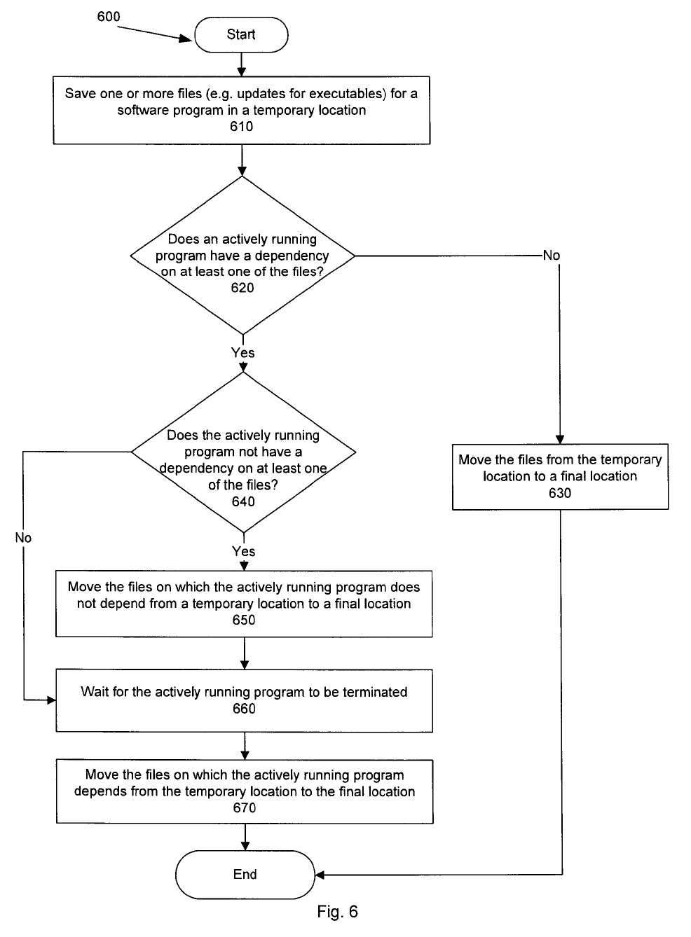

Upon receiving the determination from safety checker 230, termination checker 270 can determine whether the actively running program which depends on the update has been terminated. In one embodiment, the actively running program has been terminated when a user quits the program. In an alternate embodiment, termination checker 270 can periodically check the active processes on the system and determine if the actively running program is still one of the active processes. In another alternate embodiment, termination checker 270 can register for a notification that a particular process has terminated. In this embodiment, termination checker 270 can receive a notification from the system when that particular process has terminated. In one embodiment, a user may not be notified that the actively running program must be terminated in order for an update to be installed. In an alternate embodiment, a user can be notified that an update is to be installed once the actively running program is terminated by the user. The determining of whether an actively running program has been terminated is described below in conjunction with portions of FIGS. 5 and 6. Once termination checker 270 determines that the actively running program has been terminated, termination checker 270 can send a notice to final file mover 280.

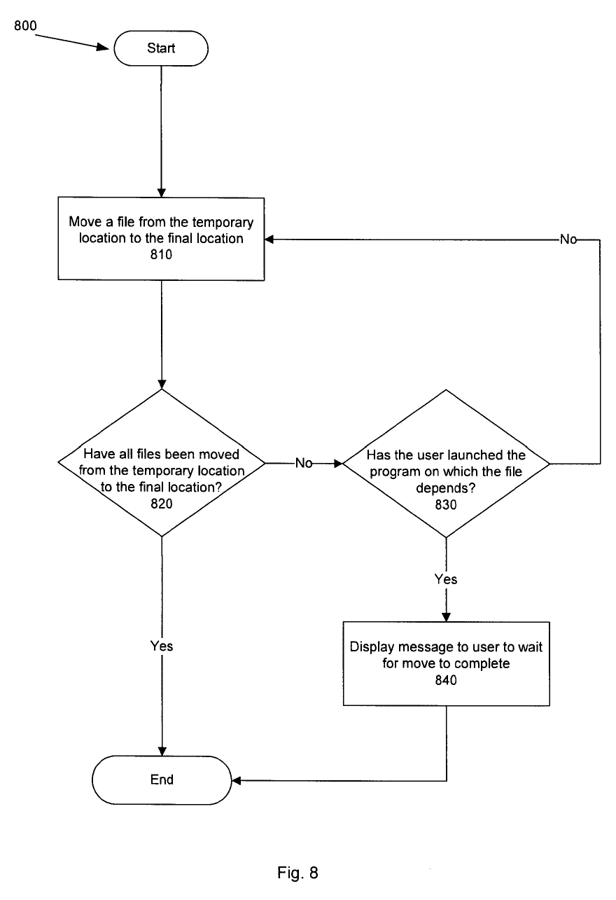

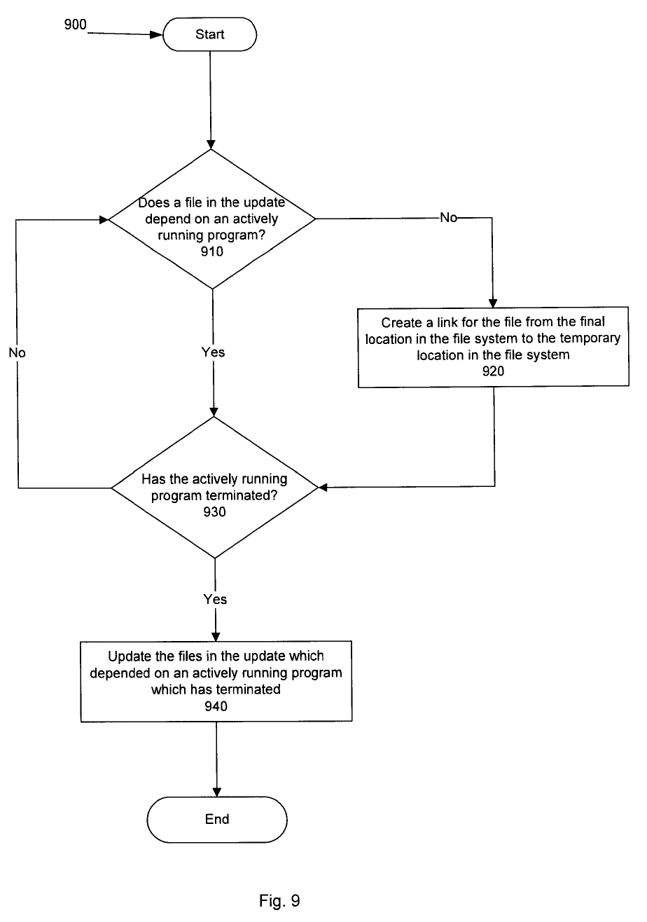

Upon receiving notice from termination checker 270, final file mover 280 can move the update from temporary location 230 to final location 240. The movement of the update is described below in conjunction with FIGS. 8 and 9.

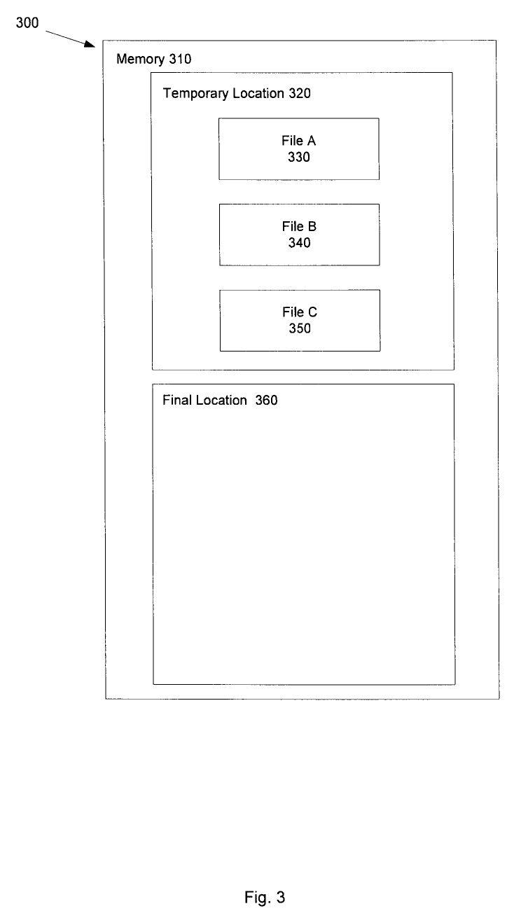

FIG. 3 illustrates an exemplary memory prior to dynamic installation of files in accordance with embodiments of the present invention. Referring to FIG. 3, memory 310 contains temporary location 320 and final location 360. Within temporary location 320, there is file A 330, file B 340, and file C 350. Prior to the dynamic installation process, temporary location 320 contains file A 330, file B 340, and file C 350, thereby not taking into account any dynamic installation of files into final location 360.

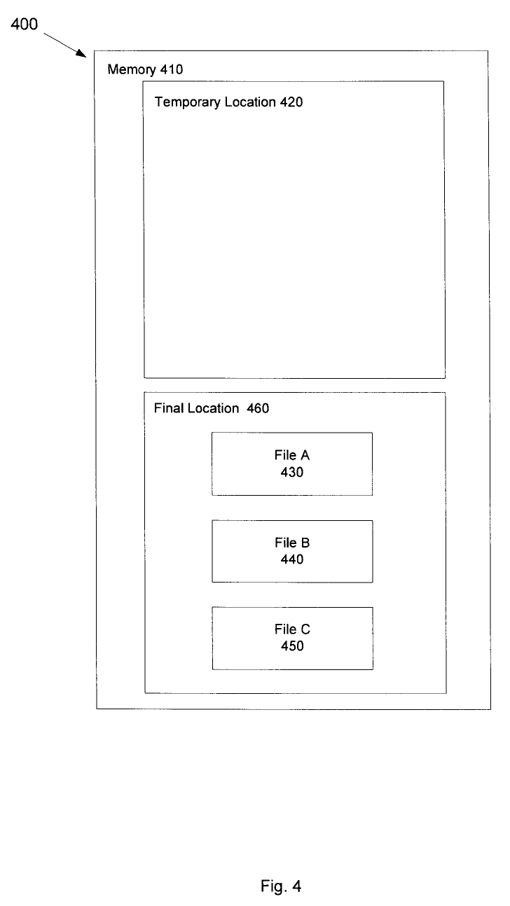

FIG. 4 illustrates an exemplary memory after dynamically installing files in accordance with embodiments of the present invention. Referring to FIG. 4, memory 410 contains temporary location 420 and final location 460. Within final location 460, there is file A 430, file B 440, and file C 450. After the dynamic installation process, file A 430, file B 440, and file C 450 have been moved from temporary location 420 to final location 460.

FIG. 5 illustrates a flow diagram of a method of dynamic installation of files in accordance with embodiments of the present invention. In one embodiment, dynamic installation of files method 500 is performed by initial file mover 250, safety checker 260, termination checker 270, and final file mover 280 of FIG. 2.

Referring to FIG. 5, method 500 starts at block 510. At block 510, the process saves an update to a software program in a temporary location. In one embodiment, the update to the software program can be a newer version of the software program and can overwrite the existing software program. In an alternate embodiment, the update can include specific files to be updated which are associated the software program, such as binary executable files or resource files. In an alternate embodiment, the update to the software program can include an updated version of a library on which a software program depends. Once the update has been moved to a temporary location, the process proceeds to block 520.

At block 520, a determination is made as to whether an actively running program has a dependency on the update to the software program. In one embodiment, an actively running program can be a software program currently executing on the system. If there is no dependency, it can be safe to install the update. In one embodiment, if there is a dependency, the installation of the update can be postponed. The determining of whether there is a dependency on the update by an actively running program is described below in conjunction with FIG. 7. If a determination is made that the update has no dependency on any actively running program, the process proceeds to block 540. If a determination is made that the update does have a dependency on any actively running program, the process proceeds to block 530.

At block 530, the process waits for the actively running program to be terminated. In one embodiment, the actively running program has been terminated when a user quits the program. In one embodiment, the system can determine that the user has quit by checking the active processes currently on the system. If the actively running program is one of the active processes, the process can wait a predetermined amount of time before checking the active processes again. In an alternate embodiment, the system can be notified once the actively running program has been terminated. In one embodiment, no notification may be given to a user that the actively running program must be terminated in order for an update to be installed. In an alternate embodiment, a user may be notified that an update can be installed once the actively running program is terminated by the user. Once the actively running program has been terminated, the process proceeds to block 540.

At block 540, the update is moved from the temporary location to a final location. In one embodiment, the update is moved using the process described below in conjunction with FIGS. 8 and 9. In one embodiment, a user is prevented from accessing the actively running program while the move is being performed. The process then ends.

Method 500 illustrates one implementation of dynamically installing files. In alternate embodiments, the order in which the blocks of method 500 are performed can be modified without departing from the scope of the invention. In one embodiment, method 500 can move the update to a temporary location prior to determining whether an actively running program has a dependency on the update. In an alternate embodiment, method 500 can determine that an actively running program has a dependency on the update and only if this dependency exists, can move the update to a temporary location.

FIG. 6 illustrates a flow diagram of an alternate method of dynamically installing files in accordance with embodiments of the present invention. In one embodiment, dynamic installation of files method 600 is performed by initial file mover 250, safety checker 260, termination checker 270, and final file mover 280 of FIG. 2.

Referring to FIG. 6, block 610 saves one or more files for a software program in a temporary location. In one embodiment, the one or more files can include a newer version of the software program and can overwrite the existing software program. In an alternate embodiment, the one or more files can include specific files to be updated which are associated the software program, such as binary executable files or resource files. In an alternate embodiment, the one or more files can include an updated version of a library on which a software program depends. Once the one or more files have been moved to a temporary location, the process proceeds to block 620.

At block 620, a determination is made as to whether an actively running program has a dependency on at least one of the files for the software program. In one embodiment, an actively running program can be a software program currently executing on the system. The determining of whether there is a dependency on the one or more files by an actively running program is described below in conjunction with FIG. 7. If there is no dependency, it can be safe to install the one or more files and the process proceeds to block 630. In one embodiment, if there is a dependency, the installation of the one or more files can be postponed, and the process proceeds to block 640.

At block 630, the process moves all of the files from the temporary location to a final location. In one embodiment, a file can be moved by updating a pointer of the file to point from the temporary location to the final location in the file system. In an alternate embodiment, the file can be moved by changing the addresses of the file to an address corresponding to the final location in the file system. The process then ends.

At block 640, the process determines whether the actively running program does not have a dependency on at least one of the files for the software program. In one embodiment, the identification information of each of the one or more files stored in the temporary location can be compared with the identification information of the actively running programs on the system. In one embodiment, if the identification information of a file compares in a predetermined manner (e.g., does not match or is not equivalent to) the identification information of each of the actively running programs, then the actively running programs do not have a dependency on that file. In one embodiment, once a file is found that the actively running programs do not have a dependency on, the process proceeds to block 650. In an alternate embodiment, the comparison can be repeated for each of the files for the software program before the process proceeds to block 650. In one embodiment, the names of the files on which the actively running programs do not have a dependency can be stored in a list in memory. The process then proceeds to block 650. If no file is found which does not compare in a predetermined manner (e.g., does not match or is not equivalent to) the identification information of each of the actively running programs, then the actively running programs all have at least one dependency on the one or more files, and the process proceeds to block 660.

At block 650, the files on which the actively running program does not depend are moved from the temporary location in the file system to the final location in the file system. In one embodiment, the movement of files can be performed based on the list containing the names of the files on which the actively running programs do not have a dependency. In this embodiment, the temporary location can be searched for each file in the list and the pointer for that file can be updated to point to the final location for that file. In an alternate embodiment, if this list does not exist, a determination can be made of the files on which the actively running program does not depend, as described above in step 640. In one embodiment, once all the files have been determined, the files can be moved from the temporary location to the final location by updating the pointer for each of those files. In an alternate embodiment, the pointer of a file can be updated as soon as it is determined that an actively running program does not have a dependency on that file, without waiting for all of the files to be determined. In an alternate embodiment, the files can be moved from the temporary location to the final location by changing the addresses of the files. In yet another alternate embodiment, a hard link can be created between the files in the temporary location and the corresponding files currently existing in the final location. The hard link causes the programs which access one of the files to use the version of the file corresponding to the temporary location. The process then proceeds to block 660.

At block 660, if an actively running program has a dependency on at least one of the files for a software program, the process can wait for the actively running program to be terminated. In one embodiment, the actively running program has been terminated when a user quits the program. In one embodiment, the system can determine that the user has quit by checking the active processes on the system. If the actively running program is still one of the active processes, the process can wait a predetermined amount of time before checking the active processes again. In an alternate embodiment, the system can be notified (e.g., status message) once the actively running program has been terminated. In one embodiment, no notification may be given to a user that the actively running program must be terminated in order for an update to be installed. In an alternate embodiment, a user may be notified that an update can be installed once the actively running program is terminated by the user. Once the actively running program has been terminated, the process proceeds to block 670.

At block 670, the files on which the actively running program depends can be moved from the temporary location to the final location. In one embodiment, the update is moved using the process described below in conjunction with FIG. 8. In one embodiment, a user is prevented from accessing the actively running program while the move is being performed. The process then ends.

Method 600 illustrates one implementation of dynamically installing files. In alternate embodiments, the order in which the blocks of method 600 are performed can be modified without departing from the scope of the invention. In one embodiment, method 600 can save the files prior to determining whether an actively running program has a dependency on one or more of the files. In an alternate embodiment, method 600 can first determine that an actively running program has a dependency on at least one of the files and only if this dependency exists, can move the files to a temporary location.

FIG. 7 illustrates a flow diagram of a method of determining whether an update is safe in accordance with embodiments of the present invention. In one embodiment determining whether an update is safe method 700 is performed by safety checker 260 of FIG. 2.

Referring to FIG. 7, at block 710, the identification information of a file associated with an update can be compared to the identification information of the actively running programs on the system. In one embodiment, the actively running programs on the system can be software programs currently executing on the system. In one embodiment, the identification information of the actively running program can include an identification number associated with an actively running program installed on the system. In an alternate embodiment, the identification information of the actively running program can include an identification number of each of the files associated with the actively running program. In this embodiment, the identification number of each file associated with the actively running program can be compared to the identification information of the file associated with the update. In one embodiment, the identification information of the file associated with the update can include an identification number of a program on the system which that file is associated with. In an alternate embodiment, the identification information of the file associated with the program can include an identification number of the file itself. In this embodiment, the identification information of the actively running program can be compared to the identification number associated with the file. The process then proceeds to block 720.

At block 720, a determination is made as to whether the identification information of the file associated with an update compares in a predetermined manner (e.g., matches or is equivalent to) the identification information of one or more of the actively running programs. In one embodiment, if the identification information of the file compares in a predetermined manner to the identification information of the one or more actively running programs, then the process can end. In an alternate embodiment, the identification information of the file can be added to a list containing the identification information of any files associated with the update which match an actively running program. In this embodiment, the process can proceed to block 730 to determine whether there are any more files associated with the update to check. If the identification information of the file compares in a predetermined manner to the identification information of the one or more actively running programs, then the process proceeds to block 730.

At block 730, the process determines whether any more files associated with the update have not been compared to the actively running programs. If there are additional files associated with the update that need to be compared, the process returns to block 710. If there are no additional files that need to be compared, the process ends.

FIG. 8 illustrates a flow diagram of a method of updating a program in accordance with embodiments of the present invention. In one embodiment, updating a program method 800 can be performed by final file mover 280 of FIG. 2. Method 800 is a more detailed description of block 540 of FIG. 5 and block 670 of FIG. 6.

Referring to FIG. 8, at block 810, a file is moved from the temporary location in the file system to a final location in the file system. In one embodiment, the file being moved can be a file that has a dependency on an actively running program. In an alternate embodiment, the file being moved can be a file that does not have a dependency on an actively running program. In one embodiment, a file can be moved by updating a pointer of the file to point from the temporary location to the final location in the file system. In an alternate embodiment, the file can be moved by changing the addresses of the file to an address corresponding to the final location in the file system. In one embodiment, an actively running program can be a software program currently executing on the system. The process then proceeds to block 820.

At block 820, a determination can be made as to whether all the files corresponding to the update have been moved from the temporary location to the final location. If all of the files have been moved from the temporary location to the final location, the process ends. If all of the files have not been moved from the temporary location to the final location, the process proceeds to block 830.

At block 830, a determination is made as to whether the user has launched the program on which the file corresponding to the update depends. If the user has not launched the program, the process returns to block 810 to move the next file associated with the update from the temporary location to the final location. If the user has launched the program, the process proceeds to block 840.

At block 840, a message is displayed to the user to wait for the update to complete prior to launching the program. In one embodiment, the message displayed can be presented through a user interface. In one embodiment, the user can be asked to click a button displayed with a message to acknowledge that the message was received. In one embodiment, in addition to a message to the user, the actively running program can be prevented from launching. In certain embodiments, block 840 is optional and is not performed. In certain embodiments, if block 840 is omitted, the process ends from block 830.

Method 800 illustrates one implementation of updating a program. In alternate embodiments, the order in which the blocks of method 800 are performed can be modified without departing from the scope of the invention. In one embodiment, method 800 can determine whether all files have been moved prior to determining whether the user has launched the program on which the file depends. In an alternate embodiment, method 800 can first determine whether the user has launched the file on which the file depends and then determine whether all files have been moved.

FIG. 9 illustrates a flow diagram of a method of updating a program in accordance with embodiments of the present invention. In one embodiment updating a program method 900 is performed by termination checker 270 and final file mover 280 of FIG. 2.

Referring to FIG. 9, at block 910, a determination is made as a file associated with an update depends on an actively running program. This determination is made as described above with reference to FIG. 7. If the file associated with the update does depend on the actively running program, the process proceeds to block 930. If there is a file associated with the update does not depend on the actively running program, the process proceeds to block 920. In one embodiment, an actively running program can be a software program currently executing on the system.

At block 920, a link is created for the file from the final location in the file system to the temporary location in the file system. In one embodiment, this link can be a hard link. In this embodiment, the hard link can cause the programs which access one of the files to use the version of the file corresponding to the temporary location. In one embodiment, the temporary location can contain a separate copy of the actively running program. The process then proceeds to block 930.

At block 930, a determination is made as to whether the actively running program has terminated. In one embodiment, the actively running program has been terminated when a user quits the program. In one embodiment, the system can determine that the user has quit by checking the active processes on the system. If the actively running program is still one of the active processes, the process waits a predetermined amount of time before checking the active processes again. In an alternate embodiment, the system can be notified once the actively running program has been terminated. In one embodiment, no notification can be given to a user that the actively running program must be terminated in order for an update to be installed. In an alternate embodiment, a user can be notified that an update can be installed once the actively running program is terminated by the user. Once the actively running program has been terminated, the process proceeds to block 940.

At block 940, the files associated with the update which depend on the actively running program, which has since been terminated, are updated. In one embodiment, the files associated with the terminated program can be moved out of the final location in the file system. In this embodiment, the files associated with the update can then be moved into the final location, thereby replacing the previous files. In an alternate embodiment, the files associated with the terminated program can be overwritten by the files associated with the update. Once the files associated with the update have been moved, the process ends.

The methods as described herein are not described with reference to any particular programming language. It will be appreciated that a variety of programming languages may be used to implement the teachings of the present invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result. It will be further appreciated that more or fewer processes may be incorporated into the methods 500, 600, 700, 800, and 900 in FIG. 5, FIG. 6, FIG. 7, FIG. 8, and FIG. 9 respectively without departing from the scope of the invention and that no particular order is implied by the arrangement of blocks shown and described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A machine-implemented method for installing one or more files on a file system, the method comprising:
saving, by a data processing system, an update to a software program in a temporary location in the file system;
determining, by the data processing system, whether an active software program has a dependency on the update;
responsive to a determination that the active software program has a dependency, waiting for the active software program to terminate; and
moving the update from the temporary location in the file system to a final location in the file system once the active software program has terminated.

2. The method of claim 1, further comprising:
responsive to the determination that the active software program has a dependency, for each file in the active software program that does not depend on the update,
creating a link from the corresponding file in the final location in the file system to the temporary location in the file system; and
updating each file in the active software program that depends on the update once the active software program has terminated.

3. The method of claim 1, wherein moving the update further comprises:
responsive to detecting that the active software program has been terminated, preventing the active software program from being accessed until the update is moved from the temporary location in the file system to the final location in the file system.

4. The method of claim 1, further comprising:
determining whether the update has been moved from the temporary location to the final location; and
responsive to a determination that the update has not been moved,
determining whether a user has launched the active software program, and
in response to a determination that the user has launched the active software program, displaying a message to the user to wait for the update to be moved.

5. The method of claim 1, wherein waiting for the active software program to terminate does not require a user to be notified.

6. The method of claim 1, wherein determining whether an active software program has a dependency on the update comprises:
determining whether identification information of the update compares in a predetermined manner to identification information of the actively running software.

7. A machine-implemented method for installing one or more files on a file system, the method comprising:
saving, by a data processing system, the one or more files in a temporary location in the file system;
determining, by a data processing system, whether an active software program has a dependency on at least one of the one or more files;
based on a determination that the active software program has a dependency,
determining whether the active software program does not have a dependency on at least one of the one or more files,
based on a determination that the active software program does not have a dependency, moving the at least one file that the active software program does not have a dependency on from the temporary location in the file system to a final location in the file system,
waiting for the active software program to terminate, and
moving the one or more files that the active software program has a dependency on from the temporary location in the file system to the final location in the file system once the active software program has terminated; and
based on a determination that the active software program does not have a dependency on the one or more files, moving the one or more files from the temporary location in the file system to the final location in the file system.

8. The method of claim 7, wherein moving the one or more files that the active software program has a dependency on further comprises:
responsive to detecting that the active software program has been terminated, preventing the active software program from being accessed until the one or more files that the active software program has a dependency on are moved from the temporary location in the file system to the final location in the file system.

9. The method of claim 7, further comprising:
determining whether the one or more files have been moved from the temporary location to the final location; and
responsive to a determination that the one or more files have not been moved,
determining whether a user has launched the active software program, and
in response to a determination that the user has launched the active software program, displaying a message to the user to wait for the one or more files to be moved.

10. The method of claim 7, wherein waiting for the active software program to terminate does not require a user to be notified.

11. The method of claim 7, wherein determining whether an active software program has a dependency on the one or more files comprises:
determining whether an identifier of the one or more files compares in a predetermined manner to an identifier of the actively running software.

12. A computer-readable storage medium comprising executable instructions to cause a processor to perform operations for installing one or more files on a file system, the instructions comprising:
saving an update to a software program in a temporary location in the file system;
determining whether an active software program has a dependency on the update;
responsive to a determination that the active software program has a dependency, waiting for the active software program to terminate; and
moving the update from the temporary location in the file system to a final location in the file system once the active software program has terminated.

13. The computer-readable storage medium of claim 12, wherein moving the update further comprises:
responsive to detecting that the active software program has been terminated, preventing the active software program from being accessed until the update is moved from the temporary location in the file system to the final location in the file system.

14. The computer-readable storage medium of claim 12, wherein the instructions further comprise:
responsive to the determination that the active software program has a dependency, for each file in the active software program that does not depend on the update,
creating a link from the corresponding file in the final location in the file system to the temporary location in the file system; and
updating each file in the active software program that depends on the update once the active software program has terminated.

15. The computer-readable storage medium of claim 12, wherein the instructions further comprise:
determining whether the update has been moved from the temporary location to the final location; and
responsive to a determination that the update has not been moved,
determining whether a user has launched the active software program, and
in response to a determination that the user has launched the active software program, displaying a message to the user to wait for the update to be moved.

16. The computer-readable storage medium of claim 12, wherein waiting for the active software program to terminate does not require a user to be notified.

17. The computer-readable storage medium of claim 12, wherein determining whether an active software program has a dependency on the update comprises:
determining whether an identifier of the update compares in a predetermined manner to an identifier of the actively running software.

18. A computer-readable storage medium comprising executable instructions to cause a processor to perform operations for installing one or more files on a file system, the instructions comprising:
determining whether an active software program has a dependency on at least one of the one or more files;
based on a determination that the active software program has a dependency,
determining whether the active software program does not have a dependency on at least one of the one or more files,
based on a determination that the active software program does not have a dependency, moving the at least one file that the active software program does not have a dependency on from the temporary location in the file system to a final location in the file system,
waiting for the active software program to terminate, and
moving the one or more files that the active software program has a dependency on from the temporary location in the file system to the final location in the file system once the active software program has terminated; and
based on a determination that the active software program does not have a dependency on the one or more files, moving the one or more files from the temporary location in the file system to the final location in the file system.

19. The computer-readable storage medium of claim 18, wherein moving the one or more files that the active software program has a dependency on further comprises:
responsive to detecting that the active software program has been terminated, preventing the active software program from being accessed until the one or more files that the active software program has a dependency on are moved from the temporary location in the file system to the final location in the file system.

20. The computer-readable storage medium of claim 18, wherein the instructions further comprise:
determining whether the one or more files have been moved from the temporary location to the final location; and
responsive to a determination that the one or more files have not been moved,
determining whether a user has launched the active software program, and
in response to a determination that the user has launched the active software program, displaying a message to the user to wait for the one or more files to be moved.

21. The computer-readable storage medium of claim 18, wherein waiting for the active software program to terminate does not require a user to be notified.

22. The computer-readable storage medium of claim 18, wherein determining whether an active software program has a dependency on the one or more files comprises:
determining whether an identifier of the one or more files compares in a predetermined manner to an identifier of the actively running software.

23. An apparatus comprising:
means for saving an update to a software program in a temporary location in the file system;
means for determining whether an active software program has a dependency on the update;
means for responsive to a determination that the active software program has a dependency, waiting for the active software program to terminate; and
means for moving the update from the temporary location in the file system to a final location in the file system once the active software program has terminated.

24. The apparatus of claim 23, further comprising:
responsive to the determination that the active software program has a dependency, for each file in the active software program that does not depend on the update,
means for creating a link from the corresponding file in the final location in the file system to the temporary location in the file system; and
means for updating each file in the active software program that depends on the update once the active software program has terminated.

25. The apparatus of claim 24, wherein the instructions further comprise:
means for determining whether the update has been moved from the temporary location to the final location; and
responsive to a determination that the update has not been moved,
means for determining whether a user has launched the active software program, and
in response to a determination that the user has launched the active software program, means for displaying a message to the user to wait for the update to be moved.

26. An apparatus comprising:
means for determining whether an active software program has a dependency on at least one of the one or more files;
based on a determination that the active software program has a dependency,
means for determining whether the active software program does not have a dependency on at least one of the one or more files,
based on a determination that the active software program does not have a dependency, means for moving the at least one file that the active software program does not have a dependency on from the temporary location in the file system to a final location in the file system,
means for waiting for the active software program to terminate, and
means for moving the one or more files that the active software program has a dependency on from the temporary location in the file system to the final location in the file system once the active software program has terminated; and
based on a determination that the active software program does not have a dependency on the one or more files, means for moving the one or more files from the temporary location in the file system to the final location in the file system.

27. The apparatus of claim 26, further comprising:
means for determining whether the one or more files have been moved from the temporary location to the final location; and
responsive to a determination that the one or more files have not been moved,
means for determining whether a user has launched the active software program, and
in response to a determination that the user has launched the active software program, means for displaying a message to the user to wait for the one or more files to be moved.

28. A computer system comprising:
a memory; and
a processor configurable by instructions stored in the memory to:
means for saving an update to a software program in a temporary location in the file system;
means for determining whether an active software program has a dependency on the update;
means for responsive to a determination that the active software program has a dependency, waiting for the active software program to terminate; and
means for moving the update from the temporary location in the file system to a final location in the file system once the active software program has terminated.

29. A computer system comprising:
a memory; and
a processor configurable by instructions stored in the memory to:
means for determining whether an active software program has a dependency on at least one of the one or more files;
based on a determination that the active software program has a dependency,
means for determining whether the active software program does not have a dependency on at least one of the one or more files,
based on a determination that the active software program does not have a dependency, means for moving the at least one file that the active software program does not have a dependency on from the temporary location in the file system to a final location in the file system,
means for waiting for the active software program to terminate, and
means for moving the one or more files that the active software program has a dependency on from the temporary location in the file system to the final location in the file system once the active software program has terminated; and
based on a determination that the active software program does not have a dependency on the one or more files, means for moving the one or more files from the temporary location in the file system to the final location in the file system.
